(19) United States
(12) Patent Application Publication
(10) Pub. No.: US 2014/0063550 A1
(43) Pub. Date: Mar. 6, 2014

(54) Printer Control System and Method

(71) Applicant: WILopEN Products LC, Deerfield Beach, FL (US)

(72) Inventor: Richard Wilen, Boca Raton, FL (US)

(73) Assignee: WILopEN Products LC, Deerfield Beach, FL (US)

(21) Appl. No.: 14/017,967

(22) Filed: Sep. 4, 2013

Related U.S. Application Data
(63) Continuation-in-part of application No. 13/838,933, filed on Mar. 15, 2013.
Application No. 13/838,933 is a continuation-in-part of application No. 12/873,031, filed on Aug. 31, 2010.
Application No. 12/873,031 is a continuation-in-part of application No. 12/846,834, filed on Jul. 30, 2010, now Pat. No. 8,616,434.
Application No. 12/846,834 is a continuation-in-part of application No. 12/846,835, filed on Jul. 30, 2010, now Pat. No. 8,622,741.
Application No. 12/846,835 is a continuation-in-part of application No. 12/777,810, filed on May 11, 2010.
Application No. 12/777,810 is a continuation-in-part of application No. 12/464,740, filed on May 12, 2009, now Pat. No. 8,577,735.
(60) Provisional application No. 61/052,377, filed on May 12, 2008.

(51) Int. Cl. G06F 3/12

(52) U.S. Cl. CPC G06F 3/1297
USPC 358/1.15

(57) ABSTRACT

A printer control system to facilitate configuration of the settings for a printing device. The printer control system may configure a printing device with an at least partially automated process. The printer control software may include a client component installed on the computer to establish a bi-directional communication to receive and transmit printer control settings. A virtual printer may be installed and configured respective to settings for a form specifiable by a user. A method is provided for facilitating the configuration and operating of a printing device.

### CROSS-REFERENCE TO RELATED APPLICATIONS

This application is a continuation-in-part of U.S. nonprovisional patent application Ser. No. 13/838,933, filed on Mar. 15, 2013; is a continuation-in-part of U.S. nonprovisional patent application Ser. No. 12/873,031, filed on Aug. 31, 2010; is a continuation-in-part of U.S. nonprovisional patent application Ser. No. 12/846,834, filed on Jul. 30, 2010; is a continuation-in-part of U.S. nonprovisional patent application Ser. No. 12/846,835, filed on Jul. 30, 2010; is a continuation-in-part of U.S. nonprovisional patent application Ser. No. 12/777,810, filed on May 11, 2010; and is a continuation-in-part of U.S. nonprovisional patent application Ser. No. 12/464,740, filed on May 12, 2009; which claims priority from U.S. provisional patent application Ser. No. 61/052,377, filed on May 12, 2008. The foregoing applications are incorporated in their entirety herein by reference.

### FIELD OF THE INVENTION

The invention relates to printing devices and methods. More particularly, the invention relates to systems and methods for controlling a printing device so as to calibrate the device based upon the electronic input of a form identification number with an associated form that is to be printed by the device.

### BACKGROUND

Printing devices, such as printers, are controlled and calibrated via computers. The control settings for a printer are generally predetermined by programming of the software so that the printer prints onto a substrate (a sheet of paper, for example) using predefined settings for one or more printer control features such as, for example, page size, substrate type, margins, print quality, one-sided versus two-sided printing, page orientation, type of document being printed, single color versus multi-color printing, typography, glyph control, line control, kerning, and spacing. With current printer technology, when a form requiring certain specific printer control settings must be printed, using the software and computer, the printer control settings must be manually changed to account for the necessary settings that typically differ from the standard settings programmed for the printer. After printing of the form is completed, using the software and computer, the printer control settings must then be manually changed to restore the settings back to the standard settings programmed for the printer.

Generally, for a user to operate a desktop printer connected to a computer, the printer manufacturer requires the user to load a ‘print driver’. The print driver is a software program that allows the printer to communicate with computer through the operating system (i.e. Windows, MAC OS, etc.). The print drivers are usually loaded either from a CD supplied with printer or downloaded from the printer manufacturer website. As part of the print driver installation, the manufacturer usually sets the printer with default settings. The default settings are designed to print most documents with merely an acceptable level of quality.

By its nature, an acceptable level of quality does not yield the highest level quality that the printer can create. Additionally, using traditional drivers and known methods to operate a printer, the print drivers will not know the size and orientation of a document or form to be printed. In order to print or imprint a document or form in a configuration other than a generic default setting, the printer settings require manipulation. Changing the printer settings can be difficult, frustrating, and involve navigating cryptic instructions. Mistakes in configuration can require trial-and-error diagnoses and can be wasteful of time and expensive ink.

What is needed is a printer control system to facilitate configuration of the settings for a printing device. What is needed is a printer control system to configure a printing device with an at least partially automated process. What is needed is a method for facilitating the configuration and operating of a printing device.

### SUMMARY

The system, methods and embodiments of the present invention facilitate configuring a printing device to create gift cards, greeting cards, envelope products, and other products printable on forms that would otherwise require manual configuration of the printing device. Users may use several desktop printer functions that they may not be familiar with to create very high quality printed and imprinted products. The present invention advantageously facilitates changing of settings, maximizing quality of the printing or imprinting onto forms. Forms may include Assembleeze™ forms provided by ShopWILopEN.com and GiftE.com. The system of the present invention may make the configuration process transparent to the user, and maintaining a printing device to be ready for use printing or imprinting one of a plurality of form types or formats.

The present invention provides a printer control system to facilitate configuration of the settings for a printing device. Additionally, the present invention provides a printer control system to configure a printing device with an at least partially automated process. The present invention also provides a method for facilitating the configuration and operating of a printing device.

According to an embodiment of the present invention, a method aspect is provided for controlling a printing device. The method may include (a) communicatively connecting a printing device to a computer that is communicatively connected to a telecommunications network. The method may also include (b) accessing a website to communicatively connect the computer to a remote application provider system via the telecommunications network. Additionally, the method may include (c) downloading a control application onto the computer from the remote application provider system via the telecommunications network. The method may include (d) installing the control application on the computer. In addition, the method may include (e) selecting a form to be printed or imprinted using the printing device, wherein the form includes a form identification number printed thereon. The method may include (f) entering the form identification number printed on the form into a form identification field of the control application. Furthermore, the method may include (g) adjusting settings of the printing device using criteria incorporated into the control application, wherein the criteria may be form-specific. The method may also include (h) printing the form using the printing device and its adjusted settings.

According to another method aspect of the invention, the method may additionally include (i) confirming the connection of a printing device to the computer, wherein the confirmation is performed electronically by software installed on the remote application provider system that is accessed via the website.

According to another method aspect of the invention, the method may additionally include (j) calibrating page settings and margin settings of the printing device before the control application is downloaded onto the computer, wherein calibration is performed electronically by software installed on the remote application provider system that is accessed via the website.

According to another method aspect of the invention, the method may additionally include (k) using the control application, copying and storing the original settings of the printing device prior to adjusting the settings of the printing device.

According to another method aspect of the invention, the method may additionally include (l) initiating the control application by manual opening of the control application software on the computer by the user when desired.

According to another method aspect of the invention, the method may additionally include (m) initiating the control application automatically each time the computer accesses the website.

According to another method aspect of the invention, the method may additionally include (n) reverting the printing device to its original settings once printing of the form is complete and the control application is terminated on the computer.

According to another method aspect of the invention, the settings of the printing device may include a plurality of controls that determine paper size of the form, print quality settings, page orientation for printing purposes, paper type of the form, and spatial information related to the orientation and location on the form of at least one space onto which data is to be printed or imprinted.

According to another method aspect of the invention, the printing device may include a desktop printer.

According to another method aspect of the invention, the printing device may include a stand-alone multifunction printer, an inkjet printer, a laser printer, a wide format plotter, a copy machine, a litho printer, and/or any other suitable type of printing device.

According to an embodiment of the present invention, a system is provided for controlling printer settings. The system may include a computer, a printing device, printer control software, and a form. The computer may include a default set of printer control settings. The printing device may be communicatively connected to the computer with which the default set of printer control settings are used to control printing features of the printing device. The printer control software may include a client component installed on the computer. The printer control software may also include machine-readable instructions and data for causing the computer to establish bi-directional communications with the printing device. The bi-directional communications may be established by requests initiated by the computer. The bi-directional communications may include a new set of printer control settings. The form may be used by the computer and printing device to control printing features of the printing device that are specifically related to the form. The form may relate to a new set of printer control settings.

In another aspect, the new set of printer control settings may include printer control settings that are different from the default set of printer control settings.

In another aspect, the printer control software may be programmed to save the default set of printer control settings while the new set of printer control settings are in use for printing the form.

In another aspect, the printer control software may be programmed to revert to the default set of printer control settings once the form has been printed using the new set of printer control settings.

In another aspect, the printer control settings may include one or more specifications for page size, substrate type, margins, print quality, one-sided versus two-sided printing, page orientation, type of document being printed, single color versus multi-color printing, typography, glyph control, line control, kerning, and spacing.

In another aspect, the printer control software may include packaged software or downloadable software.

In another aspect, the system may include a website accessibly by the computer via communicative connection to a telecommunications network, wherein the printer control software includes downloadable software stored on a remote server that is downloadable to the computer from the website.

According to an embodiment of the present invention, an image may be provided that is printable by the system. The image printed using a process including the following a series of steps. A first step may include (a) communicatively connecting a printing device to a computer that is communicatively connected to a telecommunications network. A next step may include (b) accessing a website to communicatively connect the computer to a remote application provider system via the telecommunications network. An additional step may include (c) downloading a control application onto the computer from the remote application provider system via the telecommunications network. Another step may include (d) installing the control application on the computer. Also, a step may include (e) selecting a form on which the image is to be printed or imprinted using the printing device, wherein the form includes a form identification number printed thereon. An additional step may include (f) entering the form identification number printed on the form into a form identification field of the control application. A step may include (g) adjusting settings of the printing device using criteria incorporated into the control application, wherein the criteria may be form-specific. Furthermore, a step may include (h) printing the image onto the form using the printing device and its adjusted settings.

In another aspect, the form may include paper, plastic, metallic or semi-metallic foil, paperboard, combinations of the foregoing, or any other suitable material capable of being fed through a printing device.

In another aspect, the form may include a layer. The layer may be combinable with an additional layer to be included by the form.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIGS. 1-2 are flowcharts illustrating operation of a printer control system, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention is not limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation, no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The present invention will now be described in detail with reference to embodiments thereof as illustrated in the accompanying drawings.

For purposes of convenience and not by way of limitation, paper shall be referenced as the material from which the form is constructed; however, the sheet or sheets of the form can be manufactured from any material that can be fed through a printing device and which has a surface on which the printing device may print. Suitable materials can include paper, plastic, metallic or semi-metallic foil, and paperboard. The material can be of any weight, thickness, or stiffness or rigidity as long as the material is sufficiently flexible to be moved mechanically through the printing device. The material can also be any size or shape that can be received by and mechanically fed through the printing device. Since printed forms can be spot or full page imprinted after the original printing, the sheet or sheets of material can also be any size or shape that can be received by and mechanically fed through a second or third printing device for subsequent imprinting.

The terms “print,” “printable,” and derivations thereof as used herein relate to printing on one of the multi-purpose forms during the manufacturing of the form, or printing on a surface of the form in a first instance by a manufacturer. The terms “imprint,” “imprintable,” and derivations thereof as used herein refer to printing on one of the forms by a user subsequent to manufacturing. Imprinting can be accomplished manually using a pen, pencil, or other handheld writing instrument, or mechanically using a printer or printing device. For example, the user may imprint customizations onto a blank form in the first instance where the manufacturer has not printed any information on the form during manufacturing, or the user may imprint customizations in a second, third, fourth or other instance onto a form that includes information printed thereon by the manufacturer during manufacturing. By way of further example, a form that includes information printed thereon by the manufacturer during manufacturing is printed in the first instance, customizations subsequently printed onto the form by a user are imprinted in the second instance, and additional information thereafter printed onto the same form by the same user or by another user is imprinted in the third instance.

The sheet of material forming the form can be 8.5 inches by 11 inches (letter size), 8.5 inches by 14 inches (legal size), 11 inches by 17 inches, 11 inches by 25.5 inches, 14 inches by 25.5 inches, or A4. Although the forms can be created in almost any size, to allow printing and imprinting easily on home and office desktop printing devices, in exemplary embodiments, the forms are of standard letter size or legal size. Large paper sizes can include perforations or lines of separation that can be used to separate the sheet of paper into two or more pieces that can be fed through the printing device. In this way, if a printing device capable of receiving an 11 inches by 17 inches sheet of paper is not available to the user, the form can include, for example, centerline perforations that can be used to separate the sheet of material into two letter size sheets, thereby allowing the user to print the form using the printing device that is available. In another embodiment, a form that is 11 inches by 25.5 inches in size can include perforations or lines of separation that permit the user to separate it into three letter size sheets for printing. In still another embodiment, a form that is 14 inches by 25.5 inches in size can include perforations or lines of separation that permit the user to separate it into three legal size sheets for printing.

Adhesives used in this invention can be pressure-sensitive or re-moistenable. The forms can be printed or imprinted on a printing device as described herein. The form can include one or more detachable components that may be separated from one another and from the form. For example, in one embodiment, the form can feature detachable components that include a gift card, a greeting card, and an envelope. In other embodiments, in addition to or as a substitution for the foregoing detachable components, the form can feature other detachable components such as, for example, a buck slip, an instruction piece having instructions printed thereon, a photograph, a register piece for recording transactions made using the gift card, an advertisement, a business card, or any other suitable item that can be created by printing or imprinting on the form. Finishing equipment can be used during manufacturing to vary the size or shape of each sheet or each detachable component included on each form in a package of forms. The forms can be collected in stacks of individual sheets, rolls of sheets, or accordion forms, e.g., fan-folded accordion forms, with or without sprocket holes or other elements that may or may not be needed, to feed the sheet through a printer, printing press, or other suitable printing device. Each sheet can include a plurality of identical forms, a plurality of different forms, or a plurality of forms some of which are identical and some of which are different.

The detachable components can be detached from the sheet of material by tearing, ripping, or cutting along lines of separation between each detachable component or between each detachable component and a frame. The lines of separation can be fold lines, score lines, or printed dashed or dotted lines. In an exemplary embodiment, the lines of separation can be perforations. In a most exemplary embodiment, the lines of separation can be microperforations.

The printing device used with this invention can be any printing device capable of receiving and feeding the sheets of the printable form through at least part of the device. For example, the printing device can be a home or office printer, such as, for example, a personal printer or desktop printer, or a larger stand-alone multifunction printer such as the types commonly found in offices. The printing device can also be an inkjet printer, a laser printer, a wide format plotter, a copy machine, a litho printer, or any other suitable type of printer. The printing device can be a standard printing press, a digital printing device or a variable printing device. Because the form is contemplated to be commonly used by consumers at home, the form and software used therewith may be optimized for use with home desktop printers. The printing device may be of a type capable of printing on only a single side of a sheet or on both sides of a sheet of the form. The form can also be imprinted with customizations on a digital printing press or any other type of printing device so that the user can print customizations thereon using a printing device that is available to the user.

Printing can occur in stages. In a first stage, information can be preprinted on a form during or after manufacturing. In a second stage, information can be printed on the form by a first user. In a third stage, additional information can be printed on the form by a second user. The second user may have a need to print additional information on the form after receiving it from the first user. For example, the first user may be a giftor while the second user may be a giftee. While activating the scrip using the website described herein, the giftee may be given the option to enter a contest. If the giftee wins the contest, the website may require, or the giftee may desire, that additional information (e.g., information related to a contest prize) be printed on the form during the third stage of printing.

A printer control system will now be discussed. The printer control system may include a computer, a printing device, printer control software, and a form. Each element will be discussed in more detail below. The printing device may be connected to the computer. The printer control software may be used to operate the printing device. The form may be printed by the printing device.

The computer will now be discussed in greater detail. The computer may include computerized devices capable of executing instructions stored on a medium, such as memory. An illustrative computerized device will now be discussed in greater detail, without limitation. The computerized device may include a processor, memory, network controller, and optionally an input/output (I/O) controller. Skilled artisans will appreciate additional embodiments of a computerized device that may omit one or more of the aforementioned components or include additional components without limitation. The processor may receive and analyze data. The memory may store data, which may be used by the processor to perform the analysis. The memory may also receive data indicative of results from the analysis of data by the processor.

The memory may include volatile memory modules, such as random access memory (RAM), or non-volatile memory modules, such as flash based memory Skilled artisans will appreciate the memory to additionally include storage devices, such as, for example, mechanical hard drives, solid state data, and removable storage devices.

The computerized device may also include a network controller. The network controller may receive data from other components of the computerized device to be communicated with other computerized devices via a network. The communication of data may be performed wirelessly. More specifically, without limitation, the network controller may communicate and relay information from one or more components of the computerized device, or other devices and/or components connected to the computerized device, to additional connected devices. Connected devices are intended to include data servers, additional computerized device, mobile computing devices, smart phones, tablet computers, and other electronic devices that may communicate digitally with another device. In one example, the computerized device may be used as a server to analyze and communicate data between connected devices.

The computerized device may also include an I/O interface. The I/O interface may be used to transmit data between the computerized device and extended devices. Examples of extended devices may include, but should not be limited to, a display, external storage device, human interface device, printing device, sound controller, or other components that would be apparent to a person of skill in the art. Additionally, one or more of the components of the computerized device may be communicatively connected to the other components via the I/O interface. The computerized device may control an extended device via a driver.

The components of the computerized device may interact with one another via a bus. Those of skill in the art will appreciate various forms of a bus that may be used to transmit data between one or more components of an electronic device, which are intended to be included within the scope of this disclosure.

The computerized device may communicate with one or more connected devices via a network. The computerized device may communicate over the network by using its network controller. More specifically, the network controller of the computerized device may communicate with the network controllers of the connected devices. The network may be, for example, the internet. As another example, the network may be a WLAN. However, skilled artisans will appreciate additional networks to be included within the scope of this disclosure, such as intranets, local area networks, wide area networks, peer-to-peer networks, and various other network formats. Additionally, the computerized device and/or connected devices may communicate over the network via a wired, wireless, or other connection, without limitation.

The printing device will now be discussed in greater detail. As discussed above, the printing device may include a desktop printer. The printing device may print an image or text onto a form or document. The printing device may operate using inkjet, laser, daisy wheel, or other printing techniques. The printing device may also be a stand-alone multifunction printer, an home inkjet printer, a laser printer, a wide format plotter, a copy machine, a litho-printer, or any other suitable type of printing device.

The printing device may be communicatively connected to the computer to facilitate exchange of data between the computer and the printing device. A default set of printer control settings may be used to control printing features of the printing device. Printer control settings may relate to one or more specifications for page size, substrate type, margins, print quality, one-sided versus two-sided printing, page orientation, type of document being printed, single color versus multi-color printing, typography, glyph control, line control, kerning, spacing, and other settings that would be apparent to a skilled artisan after having the benefit of this disclosure. Types of documents printable by the system may include, but should not be limited to, pages, envelopes, labels, and other documents. Printing documents that are two-sided can also be configured between duplex printing and separate printing of each side.

The default printing control setting may be altered by the system. For example, a new set of printer control settings may be applied to the printing device that are different from the default set of printer control settings to alter operation of the printing device. The system may communicate with the printing device to retrieve the default printer control settings. Similarly, the system may communicate with the printing device to update the printer control settings with optimized settings as determined by the system.

The printer control software will now be discussed in greater detail. The printer control software may load software onto desktop computers, for example, to be installed within an operating system to enable printer selection and control function. The printer control software may be offered as a software-as-a-service. The software may include proprietary instructions. Once loaded, the printer control system may provide a controllable and selectable virtual printer that operates the printing device and is capable of being engaged by the user like any other printer. The function is selectable by the user and may be applied as desired or as need may dictate.

The printer control software may include a client component installed on the computer. The client component may be operated by the computer. The printer control software may be provided via packaged media, one or more downloadable files, or another channel of distribution. The printer control software may also include machine-readable instructions and data for directing the computer to establish bi-directional communications with the printing device. For example, the computer may communicate with the printing device bi-directionally when accessing or configuring the printer control settings. The bi-directional communications may be established by requests initiated by the computer. The bi-directional communications may include a new set of printer control settings to configure the printing device.

The printer control software may be programmed to save a default set of printer control settings. Saving of settings may occur while a new set of printer control settings are in use for printing a form or document. Additionally, the printer control software may be programmed to revert to the default set of printer control settings once the form has been printed using the new set of printer control settings.

The form will now be discussed in greater detail. The form may be created using the new set of printer control settings. As discussed above, the new set of printer control settings is selectable by the system and/or user and may be communicated with the printing device by the computer. Settings relating to the form may be used by the computer and printing device to control printing features of the printing device. The system may be configured with multiple sets of printer control settings, which may correspond with multiple respective forms. Examples of forms usable with the system of the present invention are provided, without limitation, by Applicant's co-pending U.S. patent application Ser. Nos. 12/777,810, 12/846,834, 12/873,031, 12/846,835, and 61/052,377, each of which are incorporated in their entirety herein by reference.

The system may also include an interface, such as a website. The interface may be accessed using the computer. More specifically, the interface may be accessed on the computer via communicative connection to a telecommunications network. The printer control software may include downloadable software stored on a remote server. The printer control software may be downloadable to the computer from the interface. The software may be installed and/or operated on the computer. Operation of the software may control the printing device, modify printer control settings, and/or perform other functions.

An image may be printed using the printing device, which may have been configured via the printer control system. For example, the printer control system may communicatively connect a printing device to a computer, which may be communicatively connected to the telecommunications network. The system may then access a website and/or interface to communicatively connect the computer to a remote application provider system via the telecommunications network. The control application may be a component of the printer control software. A control application may be downloaded onto the computer from the remote application provider system via the telecommunications network. The control application may be installed on the computer. After being installed, the control application may be used to select settings relating to a form on which the image is to be printed or imprinted. The image may then be printed to the form using the printing device.

Settings relating to the form may be entered into the printer control system for configuration using a form identification number printed on the form or accompanying the form. For example, the form identification number may be entered into a form identification field of the control application. The printer control system may adjust settings of the printing device using pre-selected and/or dynamically configured criteria incorporated into the control application. Pre-selected criteria may include settings that are specific to one or more form. The printing device may then print the image onto the form using the adjusted settings.

The form may include paper, plastic, metallic or semi-metallic foil, paperboard, and combinations of the foregoing Skilled artisans will appreciate additional suitable materials capable of being fed through a printing device to be included within the scope of this disclosure. The form may also include one or more layer. Where multiple layers are included by the form, each layer is combinable with an additional layer to create the form. Multiple layers may beneficially alter a thickness, rigidness, or other characteristic of the form.

In operation, the printer control system may be used to facilitate configuration of a printing device to print a form and/or document. In the interest of clarity, illustrative methods of operating the printer control system will now be discussed Skilled artisans will appreciate that the following methods are provided as examples, and are not intended to limit the present invention in any way.

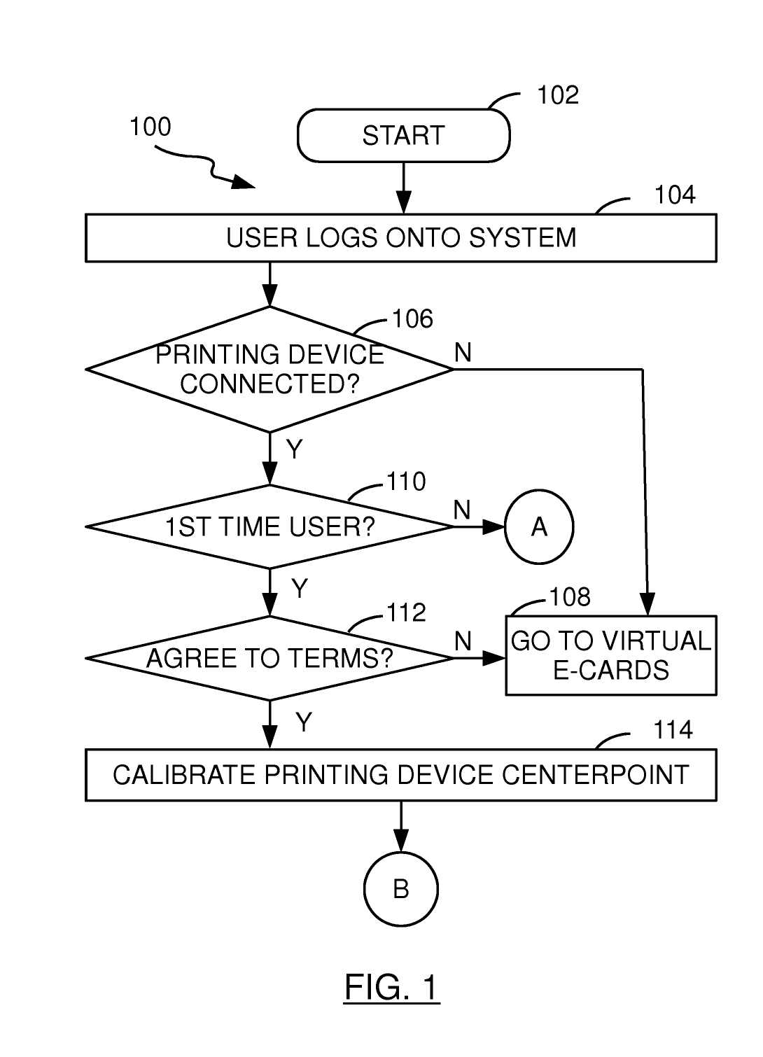

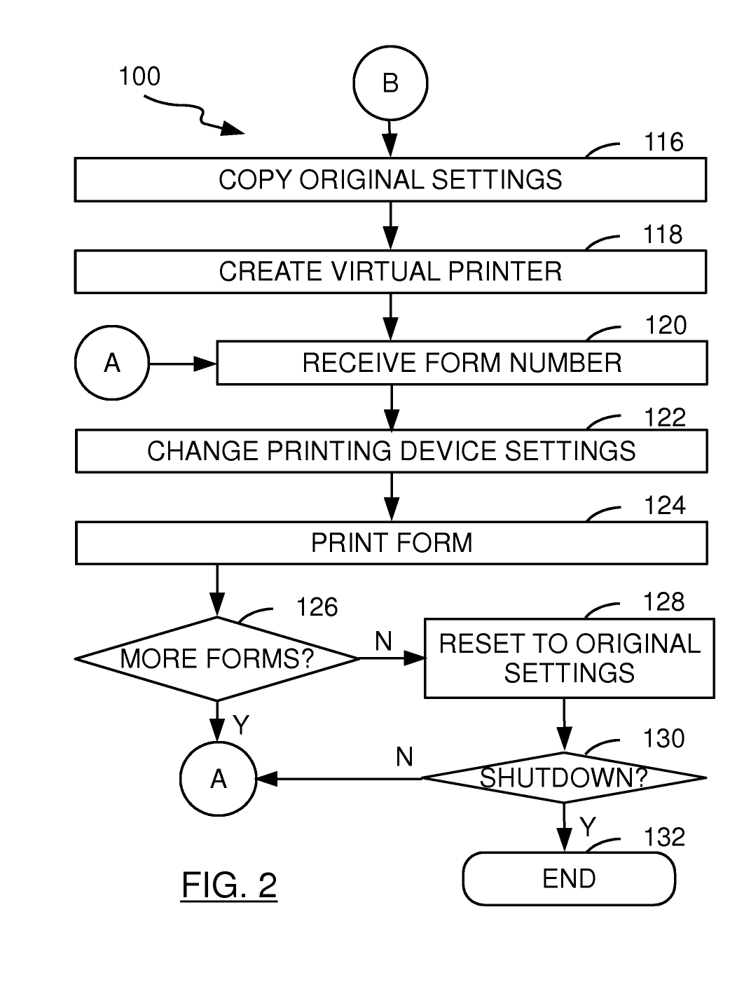

Referring now to the flowchart 100 of FIGS. 1-2, an illustrative operation of the printer control system will now be discussed. The operation may start at Block 102. A user may log onto the system, for example, via the Internet. (Block 104). The system may analyze the user's computer and confirm that the user has a connected printing device. (Block 106). If it is determined at Block 106 that no printing device is connected, the system may direct the user to an interface for creating virtual forms and/or e-cards. (Block 108). Examples of virtual forms and e-cards, accessible via an interactive gifting system, are discussed in greater detail by Applicant's co-pending U.S. patent application Ser. No. 12/464,740, which is incorporated in its entirety herein by reference. If it is determined at Block 106 that a printing device is connected to the computer, the system may determine whether the user is a first time user. (Block 110).

If it is determined at Block 110 that the user is not a first time user, the system may direct the user to an interface input a form number. (Block 120). The operation at Block 120 will be discussed in greater detail below. If it is determined at Block 110 that the user is a first time user, the first time the user may register and be credentialed on the system. The system may then prompt the user to agree to terms and install printer control software on his or her computer. (Block 112). For example, the user may be prompted to agree to download the printer control software. If it is determined at Block 112 that the user agrees to install the printer control software, the first time the user may download and install the printer control software on his or her computer. The user may then be directed by printer control software. If it is determined at Block 112 that the user declined the terms or failed to download the printer control software, the system may direct the user to the interface to create virtual forms and/or e-cards. (Block 108).

The printer control software can be used to calibrate the page and margin settings by using a calibration operation of the system. (Block 114). The system may also prompt the user to download the printer control drivers, settings, and other packages that would assist the system to interface with the printing device.

The printer control software may read and record current settings of the printing device. (Block 116). For example, the original settings from the printing device may be copied by the software. The settings may be recorded into memory, either locally or via the communications network. The printer control software may use current printer settings to create a virtual printer. (Block 118). Future changes to the settings may be made to the virtual printer as needed, which may control the physical printing device.

When the user wishes to print a form, the user may enter the number of the form to be printed into window provided by the printer control software. (Block 120). Based on the form control number, the virtual printer may adapt the printer settings to reflect a format of the form on which an image will be printed. (Block 122). For example, the printer control software may make the necessary changes to accommodate the paper form size, print-quality settings, page print orientation and paper type settings and adjusts and changes the settings to maximize the print quality for imprinting forms, for example, proprietary forms. The unique form identification number may also be used to determine whether the form is partially printed, the imprint needed, and the location of the necessary imprints to complete the form.

Operation of the printer control software controlling the physical printing device may be substantially seamless to the user. For example, the user may only be asked to enter the unique form identification number. Once this information has been received, the printer control system may substantially automate configuration of the necessary settings to successfully print the desired image to the proper form. (Block 124).

After the form has been printed using the printer control system, the printer control software may determine whether additional forms require printing at Block 126. If it is determined at Block 126 that additional forms need printing, the system may return to the operation of Block 120 and again receive a form number. If it is determined at Block 126 that no additional forms need printing, the system may reload the original settings that were recorded in the early steps of this procedure. (Block 128). This step may beneficially prepare the printing device for subsequent printing jobs, which may be directed by the printer control system or other applications operating on the computer.

The system may then determine whether a shutdown command has been received at Block 130. If no shutdown command has been received, the system may return to the operation of Block 120 and wait for a user to enter a form number. The printer control application may continue to call itself and be operative each time the user goes to print a form and enters a unique form identification number, for example, into the virtual printer interface provided by the present invention.

If it is determined at Block 130 that a shutdown command has been received, the operation may terminate at Block 132. The configuration process may be repeated if a new, replacement, or additional printer is added to the computer. The printer control system of the present invention may be configured to interface and control settings with virtually any desktop printers, agnostic of manufacturer or model.

An illustrative method for controlling a printing device will now be discussed. The method may include communicatively connecting a printing device to a computer that is communicatively connected to a telecommunications network. The method may also include accessing an interface and/or website to communicatively connect the computer to a remote application provider system via the telecommunications network. Additionally, a control application, such as the printer control software, may be downloaded onto the computer from the remote application provider system via the telecommunications network. The control application may be installed on the computer.

A form may be selected for printing or imprinting using the printing device. The form may include a form identification number printed on the form or accompanying the form. For example, the form identification number that is printed on the form may be entered into a form identification field of the control application. The control application may adjust settings of the printing device using pre-selected or dynamically configurable criteria incorporated into the control application. The criteria may be form-specific. The printing device may print the form using the printing device and its adjusted settings.

The system may also confirm the connection of a printing device to the computer. The confirmation may be performed electronically by software installed on the remote application provider system that is accessed via the website. Page settings and margin settings of the printing device may be calibrated before the control application is downloaded onto the computer, wherein calibration is performed electronically by software installed on the remote application provider system that is accessed via the website.

Using the control application, the method may include copying and storing the original settings of the printing device prior to adjusting the settings of the printing device. The control application may be initiated by manually opening of the control application software on the computer by the user when desired. Alternatively, the control application may be initiated automatically each time the computer accesses the website. The printing device may be reverted to its original settings once printing of the form is complete and the control application is terminated on the computer.

Settings of the printing device may include a plurality of controls that determine paper size of the form, print quality settings, page orientation for printing purposes, paper type of the form, and spatial information related to the orientation and location on the form of at least one space onto which data is to be printed or imprinted. Skilled artisans will appreciate additional controls to be included by the printing device consistent with the scope and spirit of the present invention.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for controlling a printing device, the method comprising the steps of:
(a) communicatively connecting a printing device to a computer that is communicatively connected to a telecommunications network;
(b) accessing a website to communicatively connect the computer to a remote application provider system via the telecommunications network;
(c) downloading a control application onto the computer from the remote application provider system via the telecommunications network;
(d) installing the control application on the computer;
(e) selecting a form to be printed or imprinted using the printing device, wherein the form comprises a form identification number printed thereon;
(f) entering the form identification number printed on the form into a form identification field of the control application;
(g) adjusting settings of the printing device using criteria incorporated into the control application, wherein the criteria are form-specific; and
(h) printing the form using the printing device and its adjusted settings.

2. The method of claim 1, wherein the method further comprises the step of:
(i) confirming connection of the printing device to the computer, wherein the confirmation is performed electronically by software installed on the remote application provider system that is accessed via the website.

3. The method of claim 1, wherein the method further comprises the step of:
(j) calibrating page settings and margin settings of the printing device before the control application is downloaded onto the computer, wherein calibration is performed electronically by software installed on the remote application provider system that is accessed via the website.

4. The method of claim 1, wherein the method further comprises the step of:
(k) using the control application, copying and storing the original settings of the printing device prior to adjusting the settings of the printing device.

5. The method of claim 1, wherein the method further comprises the step of:
(l) initiating the control application by manual opening of the control application software on the computer by a user when desired.

6. The method of claim 1, wherein the method further comprises the step of:
(m) initiating the control application automatically each time the computer accesses the website.

7. The method of claim 4, wherein the method further comprises the step of:
(n) reverting the printing device to its original settings once printing of the form is complete and the control application is to be terminated on the computer.

8. The method of claim 1, wherein the settings of the printing device comprise a plurality of controls that determine paper size of the form, print quality settings, page orientation for printing purposes, paper type of the form, and spatial information related to the orientation and location on the form of at least one space onto which data is to be printed or imprinted.

9. The method of claim 1, wherein the printing device comprises a desktop printer.

10. The method of claim 1, wherein the printing device comprises a device selected from the group consisting of: a stand-alone multifunction printer, an inkjet printer, a laser printer, a wide format plotter, a copy machine, a litho printer, and any other suitable type of printing device.

11. A system for controlling printer settings, the system comprising:
a computer comprising a default set of printer control settings;
a printing device communicatively connected to the computer with which the default set of printer control settings are used to control printing features of the printing device; and
printer control software comprising a client component installed on the computer, wherein the printer control software comprises machine-readable instructions and data for causing the computer to establish bi-directional communications with the printing device, wherein such bi-directional communications are established by requests initiated by the computer, wherein the bi-directional communications comprise a new set of printer control settings; and
a form with which the new set of printer control settings are used by the computer and printing device to control the printing features of the printing device that are specifically related to the form.

12. The system of claim 11, wherein the new set of printer control settings comprise printer control settings that are different from the default set of printer control settings.

13. The system of claim 12, wherein the printer control software is programmed to save the default set of printer control settings while the new set of printer control settings are in use for printing the form.

14. The system of claim 13, wherein the printer control software is programmed to revert to the default set of printer control settings once the form has been printed using the new set of printer control settings.

15. The system of claim 11, wherein printer control settings comprise one or more specification selected from the list consisting of: page size, substrate type, margins, print quality, one-sided versus two-sided printing, page orientation, type of document being printed, single color versus multi-color printing, typography, glyph control, line control, kerning, and spacing.

16. The system of claim 11, wherein the printer control software comprises packaged software or downloadable software.

17. The system of claim 11, wherein the system further comprises a website accessibly by the computer via communicative connection to a telecommunications network, wherein the printer control software comprises downloadable software stored on a remote server that is downloadable to the computer from the website.

18. An image printed using a process comprising the steps of:
(a) communicatively connecting a printing device to a computer that is communicatively connected to a telecommunications network;
(b) accessing a website to communicatively connect the computer to a remote application provider system via the telecommunications network;
(c) downloading a control application onto the computer from the remote application provider system via the telecommunications network;
(d) installing the control application on the computer;
(e) selecting a form on which the image is to be printed or imprinted using the printing device, wherein the form comprises a form identification number printed thereon;
(f) entering the form identification number printed on the form into a form identification field of the control application;
(g) adjusting settings of the printing device using criteria incorporated into the control application, wherein the criteria are form-specific; and
(h) printing the image onto the form using the printing device and its adjusted settings.

19. The image of claim 18, wherein the form comprises paper, plastic, metallic or semi-metallic foil, paperboard, combinations of the foregoing, or any other suitable material capable of being fed through a printing device.

20. The image of claim 18, wherein the form comprises a layer, and wherein the layer is combinable with an additional layer to be included by the form.
